(19) United States
(12) Patent Application Publication
(10) Pub. No.: US 2016/0031190 A1
(43) Pub. Date: Feb. 4, 2016

(54) ELASTOMERIC LAMINATE FOR A TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Marc GREIVELDINGER, Clermont-Ferrand (FR); Catherine GAUTHIER, Clermont-Ferrand (FR); Aurelie TRIGUEL, Clermont-Ferrand (FR)

(21) Appl. No.: 14/772,238

(22) PCT Filed: Feb. 27, 2014
(86) PCT No.: PCT/EP2014/053800

§ 371 Date: Sep. 2, 2015

(30) Foreign Application Priority Data
Mar. 5, 2013 (FR) 1351936
Mar. 22, 2013 (FR) 1352559

(51) Int. Cl. B32B 25/08; B32B 27/30; B60C 1/00; B32B 25/18

(52) U.S. Cl. CPC B32B 25/08; B32B 25/18; B32B 27/302; B60C 1/0008; B32B 2270/00; B32B 2307/7242; B60C 2005/145

(57) ABSTRACT

An airtight elastomeric laminate for tires comprises at least two superimposed layers of elastomer. The first layer is composed of a composition based on at least one thermoplastic elastomer having polystyrene and polyisobutylene blocks, the content of thermoplastic elastomer having polystyrene and polyisobutylene blocks being within a range extending from more than 50 to 100 phr and on a plasticizing system comprising from 1 to 40 phr of a plasticizing oil and from 1 to 40 phr of a hydrocarbon resin, the total content of plasticizer being within a range extending from 2 to 70 phr. The second layer is composed of a composition based on at least one diene elastomer, the content of diene elastomer being within a range extending from more than 50 to 95 phr, and on at least one thermoplastic styrene elastomer in an amount ranging from 5 to less than 50 phr.

The present invention relates to laminates for tyres comprising an airtight composition, the elastomers of which are predominantly thermoplastic elastomers having polystyrene and polyisobutylene blocks, in one of their elastomeric layers.

In a conventional tyre, the various elastomeric layers are composed of diene elastomer compositions, adhering to one another via bonds created during the crosslinking of the said elastomers. These layers thus have to be combined before the curing (or the crosslinking) in order to allow them to adhere.

It is advantageous today for tyre manufacturers to use airtight elastomeric layers comprising, as elastomers, predominantly thermoplastic elastomers having polystyrene and polyisobutylene blocks in order to benefit from the properties of these elastomers, in particular for the airtightness, the reduction in the rolling resistance and the processability.

The difficulty in the use of such layers, the elastomers of which are predominantly thermoplastic styrene elastomers (TPSs), in particular copolymers having polystyrene and polyisobutylene blocks, is their adhesion to the adjacent diene layers of conventional composition before the curing of the resulting laminate or after the curing of the layer adjacent to the layer, the elastomers of which are predominantly copolymers having polystyrene and polyisobutylene blocks.

In order to improve this adhesion, the Applicant Companies have previously described laminates for tyres comprising a layer, the elastomers of which are predominantly thermoplastic elastomers having polystyrene and polyisobutylene blocks, for example in the document WO2010/063427. In this document, the layer predominantly composed of copolymers having polystyrene and polyisobutylene blocks can adhere to a diene layer by the presence of a specific intermediate adhesive layer. While it is effective, the resulting laminate adds an additional layer to the structure of the tyre, which makes it heavier and adds a stage in the manufacture thereof.

With the aim of improving conventional tyres by the use of an airtight layer predominantly based on a thermoplastic elastomer having polystyrene and polyisobutylene blocks, while simplifying the adhesion of such a layer to an adjacent crosslinked or non-crosslinked diene layer, the Applicant Company has found, surprisingly, the laminate of the invention.

A subject-matter of the invention is thus an airtight elastomeric laminate for tyres, the said laminate comprising at least two adjacent layers of elastomer:
a first layer, composed of a composition based on at least one thermoplastic elastomer having polystyrene and polyisobutylene blocks, the content of thermoplastic elastomer having polystyrene and polyisobutylene blocks being within a range extending from more than 50 to 100 phr (parts by weight per 100 parts by weight of elastomer), and on a plasticizing system comprising from 1 to 40 phr of a plasticizing oil and from 1 to 40 phr of a hydrocarbon resin, the total content of plasticizer being within a range extending from 2 to 70 phr;
a second layer, composed of a composition based on at least one diene elastomer, the content of diene elastomer being within a range extending from more than 50 to 95 phr, and on at least one thermoplastic styrene elastomer (TPS), the content of thermoplastic styrene elastomer being within a range extending from 5 to less than 50 phr.

The presence, in the two layers, of thermoplastic styrene elastomer (TPS), including the copolymer having polystyrene and polyisobutylene blocks in the airtight layer, makes it possible to have satisfactory adhesion between the two layers of the airtight laminate of the invention. In comparison with the solutions of the prior art, the invention is of great simplicity, since it makes it possible to dispense with an intermediate layer, the only role of which would be the adhesion of the airtight layer comprising the copolymer having polystyrene and polyisobutylene blocks to the diene layer, and thus not to make the tyre heavier and thus not to increase its rolling resistance.

Another major advantage of the invention is to make possible a saving in materials since, instead of using an additional elastomeric layer for the adhesion, the invention makes it possible for a predominantly diene layer (like the compositions of conventional tyres) to adhere to an airtight layer comprising a copolymer having polystyrene and polyisobutylene blocks. This saving is furthermore highly favourable to the protection of the environment.

Furthermore, the formulation of the layers of this laminate makes possible post-curing manufacture, that is to say application of the first layer of the laminate to the second layer after curing of the latter. Thus, for example, the first layer can be applied to the second layer, after curing a tyre provided with the said second layer as radially internal layer of the tyre; in particular, this application of the first layer is possible without any treatment being necessary on the second layer.

Preferably, the invention relates to a laminate as defined above, in which the copolymer having polystyrene and polyisobutylene blocks of the first layer is a styrene/isobutylene/styrene (SIBS) copolymer.

Preferably again, the invention relates to a laminate as defined above, in which the content of thermoplastic elastomer having polystyrene and polyisobutylene blocks in the composition of the first layer is within a range extending from 70 to 100 phr, more preferably from 80 to 100 phr.

Preferably, the invention relates to a laminate as defined above, in which the thermoplastic elastomer is the only elastomer of the first layer.

Preferably, the invention relates to a laminate as defined above, in which the plasticizing system of the first layer comprises from 2 to 30 phr and preferably from 5 to 20 phr of a plasticizing oil.

Preferably again, the invention relates to a laminate as defined above, in which the plasticizing oil of the first layer is selected from the group consisting of polyolefinic oils, paraffinic oils, naphthenic oils, aromatic oils, mineral oils and the mixtures of these oils. Preferably, the plasticizing oil of the first layer is a polybutene oil and preferably a polyisobutylene oil.

Preferably, the invention relates to a laminate as defined above, in which the plasticizing system of the first layer comprises from 2 to 30 phr and preferably from 5 to 20 phr of hydrocarbon resin.

Preferably, the invention relates to a laminate as defined above, in which the hydrocarbon resin of the first layer is selected from the group consisting of cyclopentadiene or dicyclopentadiene homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Preferably, the hydrocarbon resin of the first layer is selected from the group consisting of copolymer resins of two different vinylaromatic monomers, (D)CPD/vinylaromatic, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins. More preferably, the hydrocarbon resin of the first layer is selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins, styrene/α-methylstyrene copolymer resins and the mixtures of these resins. Very preferably, the hydrocarbon resin of the first layer is a styrene/α-methylstyrene copolymer resin.

Preferably, the invention relates to a laminate as defined above, in which the total content of plasticizer is within a range extending from 5 to 45 phr. Preferably, the total content of plasticizer is within a range extending from 10 to 35 phr.

Preferably again, the invention relates to a laminate as defined above, in which the first layer additionally comprises a platy filler.

Preferably, the invention relates to a laminate as defined above, in which the first layer does not comprise a crosslinking system.

Preferably, the invention relates to a laminate as defined above, in which the elastomer blocks of the thermoplastic styrene elastomers (TPSs) of the second layer are chosen from elastomers having a glass transition temperature of less than 25° C.

Preferably again, the invention relates to a laminate as defined above, in which the elastomer blocks of the thermoplastic styrene elastomers (TPSs) of the second layer are selected from the group consisting of ethylene elastomers, diene elastomers and their mixtures. According to a preferred form, the elastomer blocks of the thermoplastic styrene elastomers (TPSs) of the second layer are chosen from ethylene elastomers. According to another preferred form, the elastomer blocks of the thermoplastic styrene elastomers (TPSs) of the second layer are chosen from diene elastomers.

Preferably, the invention relates to a laminate as defined above, in which the thermoplastic styrene elastomers (TPSs) of the second layer comprise between 5% and 50% by weight of styrene. More preferably, the thermoplastic styrene elastomers (TPSs) of the second layer are selected from the group consisting of styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS), styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS), styrene/butadiene/butylene (SBB) and styrene/butadiene/butylene/styrene (SBBS) copolymer thermoplastic elastomers and the mixtures of these copolymers.

Preferably, the invention relates to a laminate as defined above, in which the content of thermoplastic styrene elastomer (TPS) in the composition of the second layer is within a range extending from 5 to 45 phr and more preferably from 10 to 40 phr.

Preferably, the invention relates to a laminate as defined above, in which the diene elastomer of the second layer is selected from the group consisting of essentially unsaturated diene elastomers and the mixtures of these elastomers. Preferably, the diene elastomer of the second layer is selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and the mixtures of these. More preferably, the diene elastomer of the second layer is selected from the group consisting of polybutadienes, synthetic polyisoprenes, natural rubber, butadiene copolymers, isoprene copolymers and the mixtures of these elastomers.

Preferably, the invention relates to a laminate as defined above, in which the second layer comprises a reinforcing filler. Preferably, the reinforcing filler of the second layer is carbon black and/or silica. More preferably, the predominant reinforcing filler of the second layer is a carbon black.

The invention also relates to a tyre comprising a laminate as defined above.

Furthermore, the invention also relates to the use, in a pneumatic object, of a laminate as defined above.

The invention relates more particularly to the laminates as defined above, used in tyres intended to equip non-motor vehicles, such as bicycles, or motor vehicles of passenger vehicle type, SUVs (“Sport Utility Vehicles”), two-wheel vehicles (in particular motorcycles), aircraft, as well as industrial vehicles chosen from vans, “heavy-duty” vehicles—that is to say, underground trains, buses, road transport vehicles (lorries, tractors, trailers) or off-road vehicles, such as agricultural vehicles or vehicles for construction work —, or other transportation or handling vehicles.

The invention and its advantages will be easily understood in the light of the description and implementational examples which follow.

### DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer, thermoplastic and diene mixed together. Within the meaning of the present invention, thermoplastic styrene elastomers (TPSs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

For the requirements of the present invention, it is specified that, in the present patent application, “thermoplastic layer” denotes an elastomeric layer comprising, by weight, a greater amount of thermoplastic elastomer(s) than of diene elastomer(s) and “diene layer” denotes an elastomeric layer comprising, by weight, a greater amount of diene elastomer(s) than of thermoplastic elastomer(s). The airtight layer of the laminate according to the invention, predominately comprising a TPS copolymer having polystyrene and polyisobutylene blocks, is clearly a thermoplastic layer as defined above.

The laminate according to the invention exhibits an excellent adhesion between the two layers denoted, for the requirement of clarity of the invention, first and second layers (or respectively airtight thermoplastic layer and diene layer). Thus, according to the invention, the airtight thermoplastic layer as defined above can adhere with a diene layer as defined above, by virtue of the presence of a certain amount of TPS in this diene layer.

The details of the invention will be explained below by the description, in a first step, of the possible common constituents of the two layers of the laminate of the invention, then, in a second step, by the description of the specific components of each of the layers of the laminate of the invention and, finally, by the description of the adhesion between the two layers of the laminate according to the invention.

The airtight laminate according to the invention has the essential characteristic of being provided with at least two elastomeric layers referred to as “airtight thermoplastic layer” and “diene layer” with different formulations, the said layers of the said laminate comprising at least one thermoplastic styrene elastomer (TPS) as defined below, including the copolymer having polystyrene and polyisobutylene blocks in the airtight layer. In addition to the copolymer having polystyrene and polyisobutylene blocks, the airtight layer comprises a plasticizing system, the composition of which will be described in detail below. In addition to the thermoplastic styrene elastomer (TPS), the diene layer also comprises a diene elastomer; its composition will be described in detail in that which follows.

### I—COMPOSITION OF THE AIRTIGHT LAYER OF THE LAMINATE OF THE INVENTION

I-1. Thermoplastic Elastomer Having Polystyrene and Polyisobutylene Blocks

The first layer, which is airtight or more generally gastight to any inflating gas, comprises more than 50 phr of a TPS copolymer having polystyrene and polyisobutylene blocks.

“Copolymer having polystyrene and polyisobutylene blocks” should be understood as meaning, in the present patent application, any thermoplastic styrene copolymer comprising at least one polystyrene block (that is to say, one or more polystyrene blocks) and at least one polyisobutylene block (that is to say, one or more polyisobutylene blocks), with which other saturated or unsaturated blocks (for example, polyethylene and/or polypropylene blocks) and/or other monomer units may or may not be associated. Since the copolymers having polystyrene and polyisobutylene blocks comprise a polystyrene block, they come within the larger family of the thermoplastic styrene elastomers (TPSs) as described in detail below in the part describing the composition of the diene layer of the laminate of the invention. Polystyrene block should be understood, in the present description, as meaning any block resulting from the polymerization of one or more monomers based on styrene, both unsubstituted and substituted; mention may be made, among substituted styrenes, for example, of methylstyrenes (for example, α-methylstyrene, β-methylstyrene, p-methylstyrene or tert-butylstyrene), chlorostyrenes (for example, monochlorostyrene or dichlorostyrene) or bromostyrenes.

It has been found that the presence of this copolymer having polystyrene and polyisobutylene blocks, such as, in particular, styrene/isobutylene (abbreviated to “SIB”) diblock copolymers or styrene/isobutylene/styrene (abbreviated to “SIBS”) triblock copolymers, gives the laminate excellent airtightness properties while significantly reducing the hysteresis, in comparison with conventional layers based on butyl rubber.

This copolymer having polystyrene and polyisobutylene blocks is in particular selected from the group consisting of SIBs, SIBSs and the mixtures of these SIB and SIBS copolymers, by definition completely saturated.

Copolymers having polystyrene and polyisobutylene blocks, such as SIB or SIBS copolymers, are known and are available commercially, for example sold by Kaneka under the Sibstar name (e.g. Sibstar 103T, Sibstar 102T, Sibstar 073T or Sibstar 072T for the SIBSs and Sibstar 042D for the SIBs). They have, for example, been described, along with their synthesis, in Patent Documents EP 731 112, U.S. Pat. No. 4,946,899 and U.S. Pat. No. 5,260,383. They were developed, first of all, for biomedical applications and then described in various applications specific to TPS elastomers, as varied as medical equipment, parts for motor vehicles or for domestic electrical appliances, sheathing for electric wires, leaktightness parts or elastic parts (see, for example, EP 1 431 343, EP 1 561 783, EP 1 566 405 and WO 2005/103146). The tyre application is described in Patent Documents WO2009/007064 and WO2010/063427.

The gastight layer described above might optionally comprise other elastomers than the copolymer having polystyrene and polyisobutylene blocks, in a minor amount (less than 50 phr). Such additional elastomers might, for example, be diene elastomers as defined in that which follows for the diene layer of the laminate of the invention, for example natural rubber or a synthetic polyisoprene, a butyl rubber, indeed even other saturated thermoplastic styrene elastomers, within the limit of the compatibility of their microstructures. In such a case and preferably, the content of copolymer having polystyrene and polyisobutylene blocks in the first airtight composition is within a range extending from 70 to 100 phr, in particular within a range extending from 80 to 100 phr.

However, according to a particularly preferred embodiment, the copolymer having polystyrene and polyisobutylene blocks, in particular SIB or SIBS copolymer, is the only thermoplastic elastomer and more generally the only elastomer present in the gastight layer; consequently, in such a case, its content is equal to 100 phr.

The copolymer having polystyrene and polyisobutylene blocks described above, in particular SIB or SIBS copolymer, is sufficient in itself alone for the purpose of gastightness with regard to the pneumatic objects in which they are used to be fulfilled in the first elastomer layer.

I-2. Plasticizing System

The plasticizing system of the airtight layer of the laminate of the invention is composed of a plasticizing oil and of a hydrocarbon resin.

The function of the plasticizing system is to facilitate the processing, in particular the incorporation in a pneumatic object, by a lowering of the viscosity and an increase in the tackifying power of the gastight layer and thus of the laminate of the invention. This plasticizing system comprises a plasticizing oil and a hydrocarbon resin, the total content of plasticizer being within a range extending from 2 to 70 phr, preferably from 5 to 45 phr and more preferably from 10 to 35 phr.

For the requirements of the present invention, the plasticizers, that is to say the oil and the resin, are preferably compatible with the thermoplastic elastomer having polystyrene and polyisobutylene blocks. Plasticizer compatible with the thermoplastic elastomer having polystyrene and polyisobutylene blocks is understood to mean a plasticizer (oil or resin, according to the plasticizer under consideration) which exhibits, as a mixture with the thermoplastic elastomer having polystyrene and polyisobutylene blocks, a single glass transition temperature (Tg) for the elastomeric part of the mixture. The said compatibility of the plasticizers with the thermoplastic elastomer having polystyrene and polyisobutylene blocks makes possible an optimum effect of the plasticizers.

The plasticizing oil (or extending oil) is used at a content ranging from 1 to 40 phr, phr meaning parts by weight per hundred parts of total elastomer (i.e., above copolymer having polystyrene and polyisobutylene blocks plus additional elastomer, if appropriate) present in the first airtight layer.

Below the minimum indicated, there is a risk of the gastight layer and thus of the multilayer laminate exhibiting too great a viscosity to be deposited on the diene layer after curing of the latter and to penetrate into the crevices of the diene layer, whereas, above the maximum recommended, there is a danger of an excessively high cold creep capable of resulting in undesirable movements of materials by centrifuging during the rotating of the tyre.

For these reasons, it is preferable for the extending oil to be used at a content ranging from 2 to 30 phr and more preferably from 5 to 20 phr.

Use may be made of any extending oil, preferably having a weakly polar nature, capable of extending or plasticizing elastomers, in particular thermoplastic elastomers.

At ambient temperature (23° C.), these oils, which are more or less viscous, are liquids (that is to say, as a reminder, substances which have the ability to eventually assume the shape of their container), in contrast in particular to resins, which are by nature solids.

Preferably, the extending oil is selected from the group consisting of polyolefinic oils (that is to say, resulting from the polymerization of monoolefinic or diolefinic olefins), paraffinic oils, naphthenic oils (of low or high viscosity), aromatic oils, mineral oils and the mixtures of these oils.

Use is preferably made of polybutene oils, particularly polyisobutylene (abbreviated to “PIB”) oils, which have demonstrated the best compromise in properties in comparison with the other oils tested, in particular with oils of the paraffinic type.

By way of examples, polyisobutylene oils are sold in particular by Univar under the Dynapak Poly name (e.g., Dynapak Poly 190), by BASF under the Glissopal (e.g., Glissopal 1000) or Oppanol (e.g., Oppanol B12) names and by Ineos Oligomer under the name Indopol H1200. Paraffinic oils are sold, for example, by Exxon under the name Telura 618 or by Repsol under the name Extensol 51.

The number-average molecular weight (Mn) of the extending oil is preferably between 200 and 25 000 g/mol, more preferably still between 300 and 10 000 g/mol. For excessively low Mn weights, there exists a risk of migration of the oil outside the composition, whereas excessively high weights can result in excessive stiffening of this composition. An Mn weight of between 350 and 4000 g/mol, in particular between 400 and 3000 g/mol, has proved to constitute an excellent compromise for the targeted applications, in particular for use in a tyre.

The number-average molecular weight (Mn) of the extending oil is determined by SEC, the sample being dissolved beforehand in tetrahydrofuran at a concentration of approximately 1 g/1; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analytical time is 30 min. A set of two Waters columns with the Styragel HT6E name is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

A person skilled in the art will know, in the light of the description and implementational examples which follow, how to adjust the amount of extending oil as a function of the specific working conditions of the gastight thermoplastic layer, in particular of the pneumatic object in which it is intended to be used.

Also, the plasticizing system of the first layer of the laminate of the invention comprises a hydrocarbon resin.

The designation “resin” is reserved in the present patent application, by definition known to a person skilled in the art, for a compound which is solid at ambient temperature (23° C.), in contrast to a liquid plasticizing compound, such as an oil.

Hydrocarbon resins are polymers well known to a person skilled in the art, essentially based on carbon and hydrogen, which can be used in particular as plasticizing agents in polymer matrices. They have been described, for example, in the work entitled “Hydrocarbon Resins” by R. Mildenberg, M. Zander and G. Collin (New York, V C H, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic and are or are not based on petroleum (if such is the case, they are also known under the name of petroleum resins). They are by definition miscible (i.e., compatible) at the contents used with the polymer compositions for which they are intended, so as to act as true diluents. Their Tg is preferably greater than 0° C., in particular greater than 20° C. (generally between 30° C. and 120° C.).

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

In the plasticizing system, the resin is used at a content by weight ranging from 1 to 40 phr. Below 1 phr, the effect of the resin is not very noteworthy, whereas, above 40 phr, there is a danger of a simultaneous increase in the hysteresis. For these reasons, the content of resin is preferably from 2 to 30 phr and very preferably from 5 to 20 phr.

According to a preferred embodiment of the invention, the hydrocarbon resin exhibits at least any one, more preferably all, of the following characteristics:
a Tg of greater than 10° C. and more preferably of greater than 30° C.;
a softening point of greater than 50° C., preferably of greater than 80° C. (in particular of between 80° C. and 160° C.);
a number-average molar mass (Mn) of between 200 and 3000 g/mol;
a polydispersity index (PI) of less than or equal to 4 (reminder: PI=Mw/Mn with Mw the weight-average molar mass).

More preferably, this hydrocarbon resin exhibits at least any one, more preferably all, of the following characteristics:
a Tg of between 30° C. and 120° C. (in particular between 35° C. and 105° C.);
a softening point of greater than 90° C., in particular of between 110° C. and 150° C.;
an average mass Mn of between 400 and 1500 g/mol;
a polydispersity index PI of less than 3 and in particular of less than 2.

The softening point is measured according to Standard ISO 4625 (ring and ball method). The Tg is measured according to Standard ASTM D3418 (1999). The macrostructure (Mw, Mn and PI) of the hydrocarbon resin is determined by steric exclusion chromatography (SEC); solvent tetrahydrofuran; temperature 35° C.; concentration 1 g/1; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of copolymer resins of two different vinylaromatic monomers, (D)CPD/vinylaromatic, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins, styrene/α-methylstyrene copolymer resins and the mixtures of these resins. Very preferably, the resin is a styrene/α-methylstyrene copolymer resin.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, by Struktol under the name 40 MS or 40 NS (mixtures of aromatic and/or aliphatic resins), by Eastman under the name Eastotac, such as Eastotac H-142W, as regards hydrogenated aliphatic hydrocarbon resins, or also by Arizona under the name Sylvares SA 140 for styrene/α-methylstyrene resins.

I-3. Platy Fillers

The elastomers described above are sufficient in themselves alone for the multilayer laminate according to the invention to be usable; nevertheless, a platy filler can be used in the composition of the airtight layer of the laminate of the invention.

The preferred use of platy filler advantageously makes it possible to lower the coefficient of permeability (and thus to increase the airtightness) of the elastomer composition, without excessively increasing its modulus, which makes it possible to retain the ease of incorporation of the airtight layer in the pneumatic object.

“Platy” fillers are well known to a person skilled in the art. They have been used in particular in tyres in order to reduce the permeability of conventional gastight layers based on butyl rubber. In these butyl-based layers, they are generally used at relatively low contents, generally not exceeding 10 to 15 phr (see, for example, the patent documents US 2004/0194863 and WO 2006/047509).

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the mean thickness of these platy fillers, these means being calculated on a number basis. Aspect ratios reaching several tens, indeed even several hundreds, are frequent. Their mean length is preferably greater than 1 μm (that is to say that “micrometric” platy fillers are then involved), typically of between several μm (for example 5 μm) and several hundred μm (for example 500 μm, indeed even 800 μm).

Preferably, the platy fillers used in accordance with the invention are selected from the group consisting of graphites, phyllosilicates and the mixtures of such fillers. Mention will in particular be made, among phyllosilicates, of clays, talcs, micas or kaolins, it being possible for these phyllosilicates to be or not to be modified, for example by a surface treatment; mention may in particular be made, as examples of such modified phyllosilicates, of micas covered with titanium oxide or clays modified by surfactants (“organo clays”).

Use is preferably made of platy fillers having a low surface energy, that is to say which are relatively nonpolar, such as those selected from the group consisting of graphites, talcs, micas and the mixtures of such fillers, it being possible for the latter to be or not to be modified, more preferably still from the group consisting of graphites, talcs and the mixtures of such fillers. Mention may in particular be made, among graphites, of natural graphites, expanded graphites or synthetic graphites.

Mention may be made, as examples of micas, of the micas sold by CMMP (Mica-MU®, Mica-Soft® and Briomica®, for example), vermiculites (in particular the vermiculite Shawatec® sold by CMMP or the vermiculite Microlite® sold by W.R. Grace) or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The platy fillers described above are preferably used at a content by volume of preferably between 0% and 50%, more preferably between 1% and 50% and more preferably still between 5% and 50%.

According to a specific embodiment, the content of platy filler in the composition is preferably at least equal to 10% by volume of elastomer composition. Such a content by volume typically corresponds, in view of the average density of the platy fillers used (typically between 2.0 and 3.0) and of that of the TPS elastomers used, to a content by weight of greater than 20 phr, preferably at least equal to 40 phr.

In order to further increase the airtightness of the TPS elastomer layer, use may be made of an even greater content of platy filler, at least equal to 15% by volume, indeed even 20% by volume, which typically corresponds to contents by weight at least equal to 50 phr, indeed even 80 phr. Contents by weight of greater than 100 phr are even advantageously possible.

However, the content of platy filler is preferably less than 50% by volume (typically less than 500 phr), from which upper limit exposure may occur to problems of increase in the modulus, of weakening of the composition, difficulties of dispersion of the filler and of processing, without mentioning a possible negative effect on the hysteresis.

The introduction of the platy fillers into the thermoplastic elastomer composition can be carried out according to various known processes, for example by solution mixing, by bulk mixing in an internal mixer or by extrusion mixing.

I-4. Various Additives

The airtight layer or composition described above can furthermore comprise the various additives normally present in the airtight layers known to a person skilled in the art. Mention will be made, for example, of reinforcing fillers, such as carbon black or silica, non-reinforcing or inert fillers other than the platy fillers described above, colouring agents which can advantageously be used for the colouring of the composition, protection agents, such as antioxidants or antiozonants, UV stabilizers, various processing aids or other stabilizers, or promoters capable of promoting the adhesion to the remainder of the structure of the pneumatic object.

Preferably, the airtight thermoplastic layer of the multilayer laminate does not comprise all these additives at the same time and preferably, in some cases, the multilayer laminate does not comprise any of these agents.

Equally and optionally, the composition of the layers of the multilayer laminate of the invention can comprise a crosslinking system known to a person skilled in the art. Preferably, the composition does not comprise a crosslinking system.

In addition to the elastomers described above, the compositions of the multilayer laminate can also comprise, always according to a minor fraction by weight with respect to the block elastomer, one or more (non-elastomeric) thermoplastic polymers, such as those based on polyether.

### II—COMPOSITION OF THE DIENE LAYER OF THE LAMINATE OF THE INVENTION

II-1. Thermoplastic Styrene Elastomer (TPS)

The second, diene, layer comprises a TPS, always according to a minor fraction of its elastomers.

The thermoplastic styrene elastomers (abbreviated to TPSs) come within, in a known way, the family of the thermoplastic elastomers (abbreviated to TPEs). With a structure intermediate between elastomers and thermoplastic polymers, they are composed of rigid polystyrene sequences connected by flexible elastomer sequences, for example polybutadiene, polyisoprene, poly(ethylene/butylene) or polyisobutylene. They are often triblock elastomers with two rigid segments connected by a flexible segment. The rigid and flexible segments can be positioned linearly, or in a star or branched configuration. Typically, each of these segments or blocks comprises a minimum of more than 5, generally more than 10, base units (for example, styrene units and isoprene units for a styrene/isoprene/styrene block copolymer).

Styrene should be understood, in the present description, as meaning any monomer based on styrene, both unsubstituted and substituted; mention may be made, among substituted styrenes, for example, of methylstyrenes (for example, α-methylstyrene, (3-methylstyrene, p-methylstyrene or tert-butylstyrene), chlorostyrenes (for example, monochlorostyrene or dichlorostyrene) or bromostyrenes.

The number-average molecular weight (denoted Mn) of the TPS elastomer is preferably between 30 000 and 500 000 g/mol, more preferably between 40 000 and 400 000 g/mol. Below the minima indicated, there is a risk of the cohesion between the chains of the elastomer being affected, in particular due to the possible dilution of the latter by an extending oil; furthermore, there is a risk of an increase in the working temperature affecting the mechanical properties, in particular the properties at break, with the consequence of a reduced “hot” performance. Furthermore, an excessively high weight Mn can be damaging to the flexibility of the gastight layer. Thus, it has been found that a value within a range from 50 000 to 300 000 g/mol is particularly well suited, in particular to use of the composition in a tyre.

The number-average molecular weight (Mn) of the TPS elastomer is determined in a known way by steric exclusion chromatography (SEC). The sample is dissolved beforehand in tetrahydrofuran at a concentration of approximately 1 g/1 and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E columns), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The polydispersity index PI (reminder: PI=Mw/Mn, with Mw the weight-average molecular weight) of the TPS elastomer is preferably less than 3; more preferably, PI is less than 2.

According to a preferred embodiment of the invention, the content by weight of styrene in the TPS elastomer is between 5% and 50%. Below the minimum indicated, there is a risk of the thermoplastic nature of the elastomer being substantially reduced while, above the recommended maximum, the elasticity of the airtight layer can be affected. For these reasons, the styrene content is more preferably between 10% and 40%, in particular between 15% and 35%.

The elastomer blocks of the TPE for the requirements of the invention can be any elastomer known to a person skilled in the art. They generally have a Tg of less than 25° C., preferably of less than 10° C., more preferably of less than 0° C. and very preferably of less than −10° C. Preferably again, the Tg of the elastomer block of the TPE is greater than −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say a monomer comprising a carbon-carbon double bond. Mention may be made, among the blocks resulting from these ethylenic monomers, of polyalkylene blocks, such as polyisobutylene, polybutylene, polyethylene or polypropylene blocks, or also such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is preferably predominantly composed of ethylenic units. Predominantly is understood to mean a content by weight of ethylenic monomer which is the highest, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is chosen from butadiene or isoprene or a mixture comprising butadiene and isoprene.

In the case of unsaturated elastomer blocks, this elastomer block of the TPE is preferably predominantly composed of a diene elastomer part. Predominantly is understood to mean a content by weight of diene monomer which is the highest, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type; this is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined below or also it can be a monomer such as vinyl acetate.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre multilayer laminate.

The elastomer block can also be a block comprising several types of ethylenic, diene or styrene monomers as defined above.

The elastomer block can also be composed of several elastomer blocks as defined above.

The TPS elastomer can be selected in particular from the group consisting of styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS), styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS), styrene/butadiene/butylene (SBB) and styrene/butadiene/butylene/styrene (SBBS) block copolymers and the mixtures of these copolymers.

Preferably, the TPS elastomer is a copolymer having polystyrene and polyisobutylene blocks. Such a definition should be understood as meaning any thermoplastic copolymer comprising at least one polystyrene block (that is to say, one or more polystyrene blocks) and at least one polyisobutylene block (that is to say, one or more polyisobutylene blocks), with which other blocks (for example, polyethylene and/or polypropylene blocks) and/or other monomer units (for example, unsaturated units, such as diene units) may or may not be associated.

More preferably still, such a block copolymer is a styrene/isobutylene/styrene triblock copolymer (abbreviated to SIBS). SIBS elastomer or copolymer is understood to mean, in the present patent application, by definition, any styrene/isobutylene/styrene triblock elastomer in which the central polyisobutylene block may or may not be interrupted by one or more unsaturated units, in particular one or more diene units, such as isoprene units, which are optionally halogenated.

TPS elastomers are commercially available, for example sold, as regards SIBSs, by Kaneka under the Sibstar name (e.g. Sibstar 102T, Sibstar 103T or Sibstar 073T).

The content of TPS in the second layer (that is to say, the total content, if there are several copolymers having polystyrene blocks) is within a range extending from 5 to less than 50 phr, in particular within a range extending from 5 to 45 phr and more particularly within a range extending from 10 to 40 phr. Below the minimum content of TPS, the adhesive effect is not sufficient whereas, above the recommended maximum, the properties of the diene layer are detrimentally affected to an excessive extent by the strong presence of TPS.

II-2. Diene Elastomer

The composition of the diene layer comprises more diene elastomer(s) than thermoplastic elastomer(s).

Thus, the composition of the diene layer comprises at least one (that is to say, one or more) diene elastomer, which can be used alone or as a blend with at least one (that is to say, one or more) other diene elastomer (or rubber).

“Diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers, such as some butyl rubbers or copolymers of dienes and of α-olefins of EPDM type, can be described as “essentially saturated” diene elastomers (low or very low content of units of diene origin, always less than 15%).

Given these definitions, diene elastomer, whatever the above category, capable of being used in the compositions in accordance with the invention is understood more particularly to mean:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the multilayer laminate according to the present invention.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The content of diene elastomer (that is to say, the total content, if there are several of them) in this second layer is between 50 and 95 phr. According to a preferred embodiment of the invention, the content of diene elastomer (that is to say, the total content, if there are several of them) is preferably within a range extending from 55 to 95 phr and more preferably from 60 to 90 phr.

II-3. Nanometric (or Reinforcing) Fillers

The elastomers described above are sufficient in themselves alone for the multilayer laminate according to the invention to be usable; nevertheless, a reinforcing filler can be used in the composition of the diene layer of the laminate of the invention.

When a reinforcing filler is used, use may be made of any type of filler generally used for the manufacture of tyres, for example an organic filler, such as carbon black, an inorganic filler, such as silica, or also a blend of these two types of filler, in particular a blend of carbon black and silica.

When a reinforcing inorganic filler is used, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

II-4. Various Additives

The diene layer of the multilayer laminate of the invention can furthermore comprise the various additives normally present in tyre elastomeric layers known to a person skilled in the art. The choice will be made, for example, of one or more additives chosen from protection agents, such as antioxidants or antiozonants, UV stabilizers, the various processing aids or other stabilizers, or promoters capable of promoting the adhesion to the remainder of the structure of the tyre. Equally and preferably, the composition of the diene layer comprises a crosslinking system known to a person skilled in the art.

Optionally again, the composition of the layers of the multilayer laminate of the invention can comprise a plasticizing agent, such as an extending oil (or plasticizing oil) or a plasticizing resin, the role of which is to facilitate the processing of the multilayer laminate, in particular its incorporation in the tyre, by a lowering of the modulus and an increase in the tackifying power.

### III—PREPARATION OF THE MULTILAYER LAMINATE

As indicated above, the multilayer laminate of the invention thus has the essential characteristic of comprising at least two adjacent elastomer layers:
a first layer, composed of a composition based on at least one thermoplastic elastomer having polystyrene and polyisobutylene blocks, the content of thermoplastic elastomer having polystyrene and polyisobutylene blocks being within a range extending from more than 50 to 100 phr (parts by weight per 100 parts by weight of elastomer), and on a plasticizing system comprising from 1 to 40 phr of a plasticizing oil and from 1 to 40 phr of a hydrocarbon resin, the total content of plasticizer being within a range extending from 2 to 70 phr;
a second layer, composed of a composition based on at least one diene elastomer, the content of diene elastomer being within a range extending from more than 50 to 95 phr, and on at least one thermoplastic styrene elastomer (TPS), the content of thermoplastic styrene elastomer being within a range extending from 5 to less than 50 phr.

The multilayer laminate of the invention is prepared according to methods known to a person skilled in the art, by separately preparing the two layers of the laminate and by then combining the thermoplastic layer with the diene layer, before or after the curing of the latter. The combining of the thermoplastic layer with the diene layer can be carried out under the action of heat and optionally of pressure. The composition of the airtight layer of the laminate of the invention is in this instance particularly suitable for positioning of the said airtight layer after curing of the diene layer of the laminate.

III-1. First Layer or Airtight Thermoplastic Layer

The airtight thermoplastic layer of the multilayer laminate of the invention is prepared conventionally, for example by incorporation of the various components in a twin-screw extruder, so as to carry out the melting of the matrix and an incorporation of all the ingredients, followed by use of a flat die which makes it possible to produce the thermoplastic layer. More generally, the shaping of the airtight thermoplastic layer can be carried out by any method known to a person skilled in the art: extrusion, calendering, extrusion-blow moulding, injection moulding or cast film.

Preferably, the thermoplastic layer described above has a thickness of greater than 0.05 mm, more preferably of between 0.1 and 10 mm (for example, from 0.2 to 2 mm).

It will be easily understood that, according to the specific fields of application, the dimensions and the pressures involved, the embodiment of the invention can vary, the first airtight layer in fact comprising several preferred ranges of thickness. Thus, for example, for tyres of passenger vehicle type, they can have a thickness of at least 0.3 mm, preferably of between 0.5 and 2 mm. According to another example, for tyres of heavy-duty or agricultural vehicles, the preferred thickness can be between 1 and 3 mm. According to another example, for tyres of vehicles in the field of construction work or for aircraft, the preferred thickness can be between 2 and 10 mm.

III-2. Second Layer or Diene Layer

The diene layer of the multilayer laminate of the invention is prepared in appropriate mixers, using two successive phases of preparation according to a general procedure well known to a person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the crosslinking or vulcanization system is incorporated.

According to a preferred embodiment of the invention, all the base constituents of the compositions of the invention, with the exception of the vulcanization system, such as the TPS elastomers or the optional fillers, are intimately incorporated, by kneading, in the diene elastomer during the first “non-productive” phase, that is to say that at least these various base constituents are introduced into the mixer and are thermomechanically kneaded, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The final composition thus obtained is subsequently calendered, for example in the form of a layer denoted, in the present invention, diene layer.

III-3. Preparation of the Laminate

The multilayer laminate of the invention is prepared by combining the airtight thermoplastic layer with the diene layer, before or after curing of the latter. Before curing, this consists in laying the thermoplastic layer on the diene layer, in order to form the laminate of the invention, and in then carrying out the curing of the laminate or of the tyre provided with the said laminate. After curing, the thermoplastic layer is placed on the precured diene layer. In order for the adhesion to be able to be established, a temperature is needed at the interface which is greater than the processing temperature of the TPS, itself greater than the glass transition temperature (Tg), and, in the case of a semicrystalline thermoplastic block, than the melting point (M.p.) of the said TPS, optionally in combination with the application of pressure.

### IV—USE OF THE LAMINATE IN A TYRE

The laminate of the invention can be used in any type of tyre. It is particularly well-suited to use in a tyre, tyre finished product or tyre semi-finished product made of rubber, very particularly in a tyre for a motor vehicle, such as a vehicle of two-wheel, passenger vehicle or industrial type, or a non-motor vehicle, such as a bicycle.

The laminate of the invention can be manufactured by combining the layers of the laminate before curing or even after curing. More specifically, as the thermoplastic layer does not require curing, it can be combined with the diene layer of the laminate of the invention before or after the curing of this diene layer, which itself requires curing before being used in a tyre. Thus, the airtight layer of the laminate of the invention can advantageously be assembled with the diene layer of the laminate after manufacture and curing of a tyre incorporating, as final radially internal layer, the diene layer of the laminate of the invention. In this case, the assembling of the two layers of the laminate of the invention is thus subsequent to the manufacture of the tyre incorporating the diene layer of the said laminate.

The multilayer laminate of the invention can advantageously be used in the tyres of all types of vehicles, in particular in the tyres for passenger vehicles capable of running at a very high speed or the tyres for industrial vehicles, such as heavy-duty vehicles.

Such a laminate is preferably positioned on the internal wall of the pneumatic object, covering it completely or at least in part, but it can also be fully incorporated in its internal structure.

In comparison with an ordinary airtight layer based on butyl rubber, the multilayer laminate of the invention has the advantage of exhibiting a markedly lower hysteresis and thus of giving tyres a reduced rolling resistance, by the use of a thermoplastic airtight layer. Furthermore, this thermoplastic airtight layer can be positioned on the diene layer of the laminate after curing of the tyre.

Furthermore, in comparison with the known airtight layers comprising the copolymer having polystyrene and polyisobutylene blocks, the laminate of the invention exhibits the major advantage of adhering to a conventional diene layer, without requiring a specific adhesion layer, since the second layer of the laminate is this conventional layer, in which a fraction of the diene elastomer is replaced with a thermoplastic styrene elastomer (TPS).

### V—EXAMPLES

### V-1. Preparation of the Examples

The examples of multilayer laminate of the invention are prepared as indicated above.

### V-2. Description of the Tests Used

### Viscosity Measurement

The principle consists in measuring the modulus of dynamic viscosity during shear stressing. Use is made of a dynamic mechanical rheometer (RPA 2000) sold by Alpha Technologies. The sample is provided in the form of a disc with a weight of 5 g. The sample is confined using an O-ring between two plates imposing a geometry of cone/cone type. The lower plate can rotate while the upper plate is stationary; the movable jaw makes it possible to apply a dynamic angular deformation of 5% at a frequency of 10 Hz during a rise in temperature (from 40° C. to 220° C. at a rate of the order of 3° C./min); the device measures the applied torque corresponding to the angular deformation applied and deduces therefrom the modulus of dynamic viscosity η (in Pa·s) of the material during this mechanical and thermal stressing.

The results are provided in the form of a curve of modulus of the dynamic viscosity η as a function of the temperature. Two specific values of the viscosity respectively corresponding to the temperature of 50° C. and of 200° C. are noted. The comparison of the materials studied is carried out on the basis of the value of the viscosity η_{200° C.}. An arbitrary value of 100 is given for the viscosity of the control, a result greater than 100 indicating a decrease in the viscosity and thus an improvement in the viscosity performance.

### Hysteresis Measurement

The principle consists in measuring the loss modulus (E″) of a film of material during dynamic stressing. Use is made of a dynamic mechanical analyser (DMA Q800) sold by TA Instruments. The sample is provided in the form of a film with a width of 4 mm and a thickness of 1 mm. The sample holder is composed of two jaws which will grip the ends of the sample; the distance between jaws is 10 mm; the upper jaw is movable while the lower jaw is stationary; the movable jaw makes it possible to apply a static preforce of 0.1N, to which will be added a dynamic deformation of 7% at a frequency of 1 Hz during a rise in temperature (from ambient to 180° C. at 3° C./min); the loss modulus E″ brought about by the material during this mechanical and thermal stressing is recorded.

The results are provided in the form of a curve of loss modulus E″ as a function of the temperature. The comparison of the materials studied is carried out on the basis of the value of the loss modulus E″ corresponding to the temperature of 40° C. An arbitrary value of 100 is given for the loss modulus of the control, a result greater than 100 indicating a decrease in the loss modulus E″, that is to say in the hysteresis, and thus an improvement in the hysteresis performance.

### Airtightness Test (or Permeability Test)

Use is made, for this analysis, of a rigid wall permeameter, placed in an oven (temperature of 60° C. in the present case), equipped with a relative pressure sensor (calibrated in the range from 0 to 6 bar) and connected to a tube equipped with an inflation valve. The permeameter can receive standard test specimens in the disc form (for example, with a diameter of 65 mm in the present case) and with a uniform thickness which can range up to 1.5 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line giving the slope a of the loss in pressure through the tested test specimen as a function of the time, after stabilization of the system, that is to say the achievement of stable conditions under which the pressure decreases linearly as a function of the time. An arbitrary value of 100 is given for the airtightness of the control, a result greater than 100 indicating an increase in the airtightness and thus a decrease in the permeability, and thus an improvement in the permeability performance.

### Adhesion Measurement

The examples of multilayer laminate of the invention are tested with regard to the adhesion of the airtight thermoplastic layer to the diene layer according to a “peel” test. The peel test specimens are produced by bringing the two layers of the laminate into contact, each of the layers being reinforced by a fabric (so as to limit the deformation of the said layers under traction). An incipient crack is inserted between the two layers.

According to whether the adhesion is evaluated before or after curing, the mixture of the diene layer is respectively noncured or precured (180° C. for 10 minutes). In all cases, the laminate test specimen, once assembled, is brought to 180° C. under pressure for 10 minutes. Strips with a width of 30 mm are cut out using a cutting machine. The two sides of the incipient crack are subsequently placed in the jaws of a tensile testing device with the Intron® trade name. The tests are carried out at ambient temperature and at a pull rate of 100 mm/min. The tensile stresses are recorded and the latter are standardized by the width of the test specimen. A curve of strength per unit of width (in N/mm) as a function of the movable crossrail displacement of the tensile testing device (between 0 and 200 mm) is obtained. The adhesion value selected corresponds to the initiation of failure in the test specimen and thus to the maximum value of this curve. The performances of the examples are standardized with respect to the control (base 100), a result greater than 100 thus indicating an improvement in the adhesion performance.

### V-3. Examples

### V-3-1. Examples of Laminate Layers

Various airtight thermoplastic compositions of a multilayer laminate and various diene layers were prepared; the compositions are presented in Tables 1A and 1B below.

In the composition A1, 28 phr of the platy filler correspond to a content of 5% (percentage by volume).

TABLE 1A

| | Thermoplastic composition | | | | |
|---|---|---|---|---|---|
| | A1 | A2 | A3 | A4 | A5 |
| SIBS 102T, Kaneka (phr) | 100 | 100 | 100 | 100 | 100 |
| PIB H1200 Oil, Ineos (phr) | 65 | 0 | 25 | 0 | 12.5 |
| SA 140 Resin, Arizona (phr) | 0 | 0 | 0 | 25 | 12.5 |
| SYA21R Platy filler, Yamagushi | 28 | 0 | 0 | 0 | 0 |
| (phr) | | | | | |

TABLE 1B

| | Diene composition | | | | |
|---|---|---|---|---|---|
| | B1 | B2 | B3 | B4 | B5 |
| NR (1) | 55 | 38 | 38 | 42 | 24 |
| BR (2) | 20 | 14 | 14 | 28 | 16 |
| SBR (3) | 25 | 16 | 16 | 0 | 0 |
| SIS (4) | 0 | 32 | 0 | 0 | 0 |
| SEBS (5) | 0 | 0 | 32 | 0 | 0 |
| SIBS (6) | 0 | 0 | 0 | 30 | 60 |
| Carbon black (7) | 42 | 42 | 42 | 60 | 60 |
| Plasticizer (8) | 14 | 14 | 14 | 0 | 0 |
| Antioxidant (9) | 1.5 | 1.5 | 1.5 | 1.5 | 1.5 |
| Stearic acid | 1 | 1 | 1 | 0.5 | 0.5 |
| ZnO | 3 | 3 | 3 | 3 | 3 |
| Sulphur | 2 | 2 | 2 | 2.5 | 2.5 |
| Accelerator (10) | 1 | 1 | 1 | 1.5 | 1.5 |

(1) NR, natural rubber
(2) BR, polybutadiene with 4% of 1,2- units and 93% of cis-1,4- units (Tg = −106° C.)
(3) Solution SBR, copolymer of styrene and butadiene with 25% of styrene units and 48% of 1,2- units of the butadiene part (Tg of −48° C.)
(4) SIS, D1161, sold by Kraton
(5) SEBS, G1654, sold by Kraton
(6) SIBS, Sibstar 102T, sold by Kaneka
(7) ASTM N347 or ASTM N683 grade, sold by Cabot
(8) MES oil, Catenex SNR, sold by Shell
(9) N-(1,3-Dimethylbutyl)-N′-phenyl-p-phenylenediamine, 6-PPD, from Flexsys
(10) N-Cyclohexyl-2-benzothiazolesulphenamide, Santocure CBS, from Flexsys

### V-3-2. Examples of Laminates Having Improved Adhesion

Assembling the Layers Before Curing

In a first step, the composition A1 and various diene layers were prepared, assembled before curing and tested as indicated above; the adhesion results are presented in Table 2 below.

TABLE 2

| | Multilayer laminate | | | | |
|---|---|---|---|---|---|
| | A1/B1 | A1/B2 | A1/B3 | A1/B4 | A1/B5 |
| Adhesion (%) | 100 | 264 | 560 | 390 | 472 |

The results presented in Table 2 demonstrate the excellent results in adhesion of the laminate in which the diene layer comprises a thermoplastic styrene elastomer, compared with a situation in which the thermoplastic layer is combined with a conventional diene layer (that is to say, not comprising any TPS at all in its composition). It is also noted that the adhesion of the laminate is of the same level as the adhesion of a laminate of two thermoplastic layers represented by the combination of A1 with B5.

Assembling the Layers after Curing

In a second step, the thermoplastic composition A1 and the layers recorded as B1, B4 and B5 defined above were prepared, assembled after curing and tested as indicated above; the adhesion results are presented in Table 3 below.

TABLE 3

| | Multilayer laminate | | |
|---|---|---|---|
| | A1/B1 | A1/B4 | A1/B5 |
| Adhesion (%) | 100 | 440 | 361 |

The results presented in Table 3 demonstrate the excellent results in adhesion of the laminate in which the diene layer comprises a thermoplastic styrene elastomer, including after curing the diene layer. It is also noted that the control A1/B5 demonstrates that a TPS content of more than 50 phr in the “diene” layer does not make it possible to obtain as good an adhesion as with the laminate in which the diene layer comprises a content of thermoplastic styrene elastomer within a range extending from 5 to less than 50 phr.

Furthermore, for an assembling of the first layer of the laminate (the airtight thermoplastic layer) with the second layer of the laminate (the diene layer) after curing of the latter, the Applicant Companies have continued their studies in order to obtain a first layer which can be easily deposited under hot conditions (for example at 200° C.) on the precured diene layer, without losing the good adhesion observed above and making it possible in particular to obtain a satisfactory airtightness and a satisfactory hysteresis.

### V-3-3. Example of Laminates According to the Invention

A laminate according to the invention (A5/B3) including, in the first layer, the plasticizing system described above was prepared and tested, in comparison with controls not possessing the plasticizing system specific to the invention (A2/B3, A3/B3 and A4/B3). The results are presented in Table 4.

TABLE 4

| | Multilayer laminate | | | |
|---|---|---|---|---|
| | A2/B3 | A3/B3 | A4/B3 | A5/B3 |
| Viscosity performance at | 100 | 145 | 120 | 145 |
| 200° C. | | | | |
| Hysteresis performance | 100 | 185 | 46 | 130 |
| Permeability performance | 100 | 78 | 129 | 124 |
| Adhesion performance | 100 | 78 | 105 | 104 |

The results presented in Table 4 show that only the plasticizing system according to the invention (laminate A5/B3) makes it possible to simultaneously improve the viscosity at 200° C., the hysteresis and the permeability of the laminate, while retaining good adhesion between the two layers. This is because the use of oil alone has a detrimental effect on the permeability and adhesion performances, while the use of resin alone has a detrimental effect on the performance in hysteresis.

In conclusion, in comparison with the known laminates using an adhesion layer to assemble an airtight thermoplastic layer and a diene layer, the invention makes it possible to dispense with the adhesion layer, in particular by inserting a fraction of TPS elastomer into the diene layer, while making it possible to have a level of viscosity which facilitates the assembling after the curing of the diene layer and while in addition promoting the permeability and hysteresis performances.

1.-33. (canceled)

34. An airtight elastomeric laminate for tires comprising at least two superimposed layers of elastomer:
a first layer comprising a composition based on
at least one thermoplastic elastomer having polystyrene and polyisobutylene blocks in an amount ranging from more than 50 to 100 phr, and
a plasticizing system comprising from 1 to 40 phr of a plasticizing oil and from 1 to 40 phr of a hydrocarbon resin, the total content of plasticizer being within a range extending from 2 to 70 phr; and
a second layer comprising a composition based on
at least one diene elastomer in an amount ranging from more than 50 to 95 phr, and
at least one thermoplastic styrene elastomer in an amount ranging from 5 to less than 50 phr.

35. The laminate according to claim 34, wherein the at least one thermoplastic elastomer having polystyrene and polyisobutylene blocks of the first layer is a styrene/isobutylene/styrene (SIBS) copolymer.

36. The laminate according to claim 34, wherein the amount of the at least one thermoplastic elastomer having polystyrene and polyisobutylene blocks in the composition of the first layer ranges from 70 to 100 phr.

37. The laminate according to claim 36, wherein the amount of the at least one thermoplastic elastomer having polystyrene and polyisobutylene blocks in the composition of the first layer ranges from 80 to 100 phr.

38. The laminate according to claim 37, wherein the at least one thermoplastic elastomer having polystyrene and polyisobutylene blocks is the only elastomer of the first layer.

39. The laminate according to claim 34, wherein the plasticizing system of the first layer comprises from 2 to 30 phr of the plasticizing oil.

40. The laminate according to claim 39, wherein the plasticizing system of the first layer comprises from 5 to 20 phr of the plasticizing oil.

41. The laminate according to claim 34, wherein the plasticizing oil of the first layer is selected from the group consisting of polyolefinic oils, paraffinic oils, naphthenic oils, aromatic oils, mineral oils and mixtures thereof.

42. The laminate according to claim 41, wherein the plasticizing oil of the first layer is a polybutene oil.

43. The laminate according to claim 42, wherein the plasticizing oil of the first layer is a polyisobutylene oil.

44. The laminate according to claim 34, wherein the plasticizing system of the first layer comprises from 2 to 30 phr of hydrocarbon resin.

45. The laminate according to claim 44, wherein the plasticizing system of the first layer comprises from 5 to 20 phr of hydrocarbon resin.

46. The laminate according to claim 34, wherein the hydrocarbon resin of the first layer is selected from the group consisting of cyclopentadiene or dicyclopentadiene homopolymer or copolymer resins, terpene homopolymer or copolymer resins, terpene/phenol homopolymer or copolymer resins, C5 fraction homopolymer or copolymer resins, C9 fraction homopolymer or copolymer resins, α-methylstyrene homopolymer or copolymer resins and mixtures thereof.

47. The laminate according to claim 46, wherein the hydrocarbon resin of the first layer is selected from the group consisting of copolymer resins of two different vinylaromatic monomers, (D)CPD/vinylaromatic, (D)CPD/terpene copolymer resins, (D)CPD/C5 fraction copolymer resins, (D)CPD/C5 fraction copolymer resins, (D)CPD/C9 fraction copolymer resins, terpene/vinylaromatic copolymer resins, terpene/phenol copolymer resins, C5 fraction/vinylaromatic copolymer resins and mixtures thereof.

48. The laminate according to claim 47, wherein the hydrocarbon resin of the first layer is selected from the group consisting of (D)CPD homopolymer resins, (D)CPD/styrene copolymer resins, polylimonene resins, limonene/styrene copolymer resins, limonene/D(CPD) copolymer resins, C5 fraction/styrene copolymer resins, C5 fraction/C9 fraction copolymer resins, styrene/α-methylstyrene copolymer resins and mixtures thereof.

49. The laminate according to claim 48, wherein the hydrocarbon resin of the first layer is a styrene/α-methylstyrene copolymer resin.

50. The laminate according to claim 34, wherein the total content of plasticizer is within a range extending from 5 to 45 phr.

51. The laminate according to claim 50, wherein the total content of plasticizer is within a range extending from 10 to 35 phr.

52. The laminate according to claim 34, wherein the first layer additionally comprises a platy filler.

53. The laminate according to claim 34, wherein the first layer does not comprise a crosslinking system.

54. The laminate according to claim 34, wherein the elastomer blocks of the at least one thermoplastic styrene elastomer of the second layer are chosen from elastomers having a glass transition temperature of less than 25° C.

55. The laminate according to claim 34, wherein the elastomer blocks of the at least one thermoplastic styrene elastomer of the second layer are selected from the group consisting of ethylene elastomers, diene elastomers and mixtures thereof.

56. The laminate according to claim 55, wherein the elastomer blocks of the at least one thermoplastic styrene elastomer of the second layer are chosen from ethylene elastomers.

57. The laminate according to claim 55, wherein the elastomer blocks of the at least one thermoplastic styrene elastomer of the second layer are chosen from diene elastomers.

58. The laminate according to claim 34, wherein the at least one thermoplastic styrene elastomer of the second layer comprises between 5% and 50% by weight of styrene.

59. The laminate according to claim 34, wherein the at least one thermoplastic styrene elastomer of the second layer is selected from the group consisting of styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS), styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS), styrene/butadiene/butylene (SBB) and styrene/butadiene/butylene/styrene (SBBS) copolymer thermoplastic elastomers and mixtures thereof.

60. The laminate according to claim 34, wherein the content of the at least one thermoplastic styrene elastomer of the second layer is within a range extending from 5 to 45 phr.

61. The laminate according to claim 60, wherein the content of the at least one thermoplastic styrene elastomer of the second layer is within a range extending from 10 to 40 phr.

62. The laminate according to claim 34, wherein the at least one diene elastomer of the second layer is selected from the group consisting of essentially unsaturated diene elastomers and mixtures thereof.

63. The laminate according to claim 62, wherein the at least one diene elastomer of the second layer is selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and mixtures thereof.

64. The laminate according to claim 63, wherein the at least one diene elastomer of the second layer is selected from the group consisting of polybutadienes, synthetic polyisoprenes, natural rubber, butadiene copolymers, isoprene copolymers and mixtures thereof.

65. The laminate according to claim 34, wherein the second layer further comprises a reinforcing filler.

66. The laminate according to claim 65, wherein the reinforcing filler of the second layer is carbon black and/or silica.

67. The laminate according to claim 66, wherein carbon black is the predominant reinforcing filler of the second layer.

68. A tire comprising a laminate according to claim 34.

69. A pneumatic object comprising a laminate according to claim 34.
